(19) United States
(12) Patent Application Publication
(10) Pub. No.: US 2014/0129919 A1
(43) Pub. Date: May 8, 2014

(54) Method for Embedding Captured Content from one location to a host location

(71) Applicant: Eric R. Benson, Phoenix, AZ (US)

(72) Inventor: Eric R. Benson, Phoenix, AZ (US)

(21) Appl. No.: 13/670,638

(22) Filed: Nov. 7, 2012

(51) Int. Cl. G06F 17/00

(52) U.S. Cl. 715/234

(57) ABSTRACT

The present invention includes a software tool, or widget, that links content to, rather than embeds content on, a host location from captured content from a subject location. Specifically, a the present invention includes a software tool or application that easily enables a user to capture content or a portion of content from one location (such as a web page, electronic document, or file on a server) and to embed code pointing to that captured content in another location (such as a user's blog-site, Facebook page, other social media site, or similar). This software tool or application, termed herein as a “WallWidget,” is a portable portion of code that may be installed or executed within any separate HTML, flash, or similar social media site, a webpage, a smart phone, or desktop by an end user without necessitating additional compilation of that code portion.

### PRIORITY CLAIM

The present application claims benefit under 35 USC Section 119(e) of U.S. Provisional Patent Application Ser. No. 61/556,621 filed on 2011-11-07. The present application is based on and claims priority from this application, the disclosure of which is hereby expressly incorporated herein by reference.

### BACKGROUND

Prior art widgets require cutting and pasting which can be complex and requiring a fairly high level of skill, and is not a convenient way for most users of social media sites to create embedded content on their blog, website, or favorite social media hosted site. The current state of the art requires cutting and pasting content from one source, such as a web site or contents on a local drive, and the current best practices provide a widget template. However, a widget template still requires skilled and or experienced programmers to fully function. Additionally, the desired content for a widget in the prior art must be available at a known location that is accessible to the user at the time they create the widget. Further, this content must remain available at the known location for the entire duration that embedded content is displayed on the second location (the user's social media page, for example).

Thus, there is a need for a tool and system that reduces the requisite skill level required to embed captured content from one location (for example, a website, blog, or social media page) in a second location (the user's social media page, for example), and to eliminate the complex cutting and pasting taught in the current art. Further, there is a need for an API (Application Programming Interface) that scans a subject website for links to every asset and assembles these links in a database associated with the user's desired content for embedding on a website and allows for current and dynamic content to be displayed within a second website without user manipulation, intervention, or updating.

### SUMMARY OF THE INVENTION

A WallWidget is an embedded element of code that runs within or atop other elements of computing code. A WallWidget may be created by cutting and pasting code elements or by a wizard that directs the user in a simple step-by-step process to generate the desired WallWidget. In particular cutting and pasting may be performed to or from anywhere on the web. WallWidgets may be static or dynamic, or live and current with the underlying content, such as data that may be within social websites such as Facebook, blogs, or within specific web pages. This means that a dynamic WallWidget will change with the content of the subject website meaning that whenever the underlying content changes, so too will the WallWidget created therefrom, whether hosted within a social website, Facebook, a blog or webpage or any other digital venue.

This invention is focused on a method of displaying information within a WallWidget by utilizing links to assets rather than hosting the assets on a particular server. Also disclosed is a user interface for the use and creation of such WallWidgets utilizing a very simple and easy to use online wizard system designed to enable a novice to create, distribute, manage, and monetize these WallWidgets so that they can be used in online marketing venues such as a pay per click service, such as Clickbank.com, while maintaining an affiliate's Identification code for proper credit using a preferred embodiment of the present invention's method.

One preferred embodiment according to the present invention includes a method of creating a WallWidget utilizing a simple easy to use wizard that directs the novice user through the steps to create a WallWidget that can then be easily placed in a Facebook wall post, or any other web page, with a single click after it is created. Once the WallWidget is placed on the wall or other website, a user can interact with it and view the contents of the subject website from within the WallWidget window that can be of various sizes.

These WallWidgets can also be configured to display users favorite videos, music, photos, games, chat links, and other entertainment elements. Key to the WallWidgets API is the integration of a “mini web browser” within the WallWidget that provides a “remote view” or “portal” of the website that does not use the prior art method of hosting the subject website. The WallWidgets internal mini web browser, by virtue of the API, organizes links to the subject website assets to provide the viewer the ability to enjoy the subject website within the WallWidget.

One advantage of the present invention includes if the subject website is changed so too will the WallWidget change without storing any of the subject assets on a particular server.

### DRAWING

FIG. 1 is a screen shot representing a step of a user interface wizard according to one preferred embodiment of the present invention.

FIG. 2 is a screen shot representing another step of the user interface wizard of FIG. 1.

FIG. 3 is a screen shot representing another step after the API indexed a subject location of the user interface wizard of FIG. 1.

FIG. 4 is a screen shot representing another step after the API indexed a subject location.

FIG. 5 is a screen shot representing user customization of the wizard of FIG. 1.

FIG. 6 is a screen shot showing a WallWidget on a Facebook page.

FIG. 7 is a screen shot representing captured content on a host location.

FIG. 8 is a screen shot showing a WallWidget in a hyperlink.

FIG. 9 is a screen shot showing a product for sale on a website accessed by a method according to the present invention.

FIG. 10 is a screen shot of a downloadable product on a website accessed by a method according to the present invention.

FIG. 11 is a screen shot of a membership site accessed by a method according to the present invention.

FIG. 12 is a screen shot of an affiliate ID according to a method according to the present invention.

FIG. 13 is a screen shot of another step of an embodiment of the present invention.

FIG. 14 is a screen shot of an embodiment of the present invention.

FIG. 15 is system of the present invention.

FIG. 16 is a computer adapted to run the method of the present invention.

FIG. 17 is a screen shot of a shopping cart affiliate id tracking system according to a preferred method of the present invention.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

The present invention relates to an improved method for embedding captured content from one location and displaying that content in mini browser on a second, host location. The software constructs that implement the methods according to preferred embodiments of the present invention are generally referred to as widgets or applications in the art. However, the present invention departs from the conventional teaching in the art, as will be appreciated by those skilled in the art, by interpreting the appended claims in relation to this description and drawings contained herein. This improved method and software tool is termed herein generally as a “WallWidget”, which—in one preferred embodiment—is an asset indexing microsite with a unique cookie setting method that utilizes a mini browser and a wizard for simple creation by a user. As such, the present invention works well as an advertising microsite. Further, the present invention enables users to display content captured from one location on a second location more easily and with less skill than taught in the known art.

To help define a WallWidget, exemplary methods to create and methods to utilize a WallWidget in various web applications are explained. The methods include how the WallWidget is monetized and proper affiliate ID's are preserved as well as how the WallWidget may be easily created by a novice user using a wizard to guide through a number of simplified steps to create the WallWidget.

To illustrate various contemplated embodiments of the present invention, some elements in many of the figures descriptions are greatly simplified to present a more clear description of the present invention. Eliminating these elements in the description of the API methodology, for example, should not be interpreted as being omitted from the invention as a person of ordinary skill would recognize what these omitted elements are and how they would be incorporated into the present invention.

The term “widget” is generally understood by those with ordinary skill in the art and refers broadly to a sequence of software code that executes a pre-determined subroutine or operation when invoked. In the known art, the term widget refers to embedded code that typically are comprised of static code that may make calls to dynamic content but are not coded in such a way as to operate as a mini browser. In contrast the WallWidget according to preferred methods of the present invention embeds code consisting of both static code that may make calls to dynamic content but is coded in a way to operate as a mini browser and or microsite.

The term “subject website” refers to the website that is utilized to derive the contents to be displayed within the WallWidget, wherein the WallWidget is placed on a second location (also termed a target or hosting location or website).

The term “web browser” refers to a software application for retrieving, presenting, and traversing information resources on the World Wide Web. A web browser can also be defined as an application software or program designed to enable users to access, retrieve and view documents and other resources on the Internet.

The term “affiliate” refers to a person or business in Affiliate Internet Marketing and is a marketing practice in which a business rewards one or more affiliates for each sale, or visitor, or customer brought about by the affiliate's own marketing efforts. The affiliate has a unique ID that identifies it for each transaction that occurs as a result of publishing the affiliate's content on the web when someone interacts with that content.

The term “API” refers to an Application Programming Interface (API), which refers to a set of rules (‘software code’) and specifications that software programs can follow to communicate with each other. It serves as an interface between different software programs and facilitates their interaction. An API may be created for a WallWidget, applications, libraries, operating systems, etc., as a way of defining their “vocabularies” and resources request conventions (e.g. function-calling conventions). It may include specifications for routines, data structures, object classes, and protocols used to communicate between the consumer program and the implementer program of the API.

The term “wizard” refers to a simplified user interface that presents the user with a sequence of dialog boxes and or video sequences that lead the user through a series of well-defined steps. Tasks that are complex, infrequently performed, or unfamiliar are easier to perform using a wizard and are aimed at the novice. The wizard enables a novice to emulate an expert by guiding the user through a series of yes or no questions to solve a problem.

The term “cookie” also known as an HTTP cookie, web cookie, or browser cookie, is used for an origin website to send state information to a user's browser and for the browser to return the state information to the origin site. The state information can be used for authentication, identification of a user session, user's preferences, shopping cart contents, or anything else that can be accomplished through storing text data on the user's computer. In the case of Affiliate ID's a cookie is set in the computer when a user visits the site and provides for proper credit being given to the owner of the origin referral website or affiliate link.

In various preferred embodiments of the present invention, a term “WallWidget” is used to describe a new concept that is essential to the present invention. Without limiting the meaning of this term, WallWidget generally refers to an embedded element of code that can be placed to run within or on top of other elements of computing code. For example, a WallWidget can refer to what one might call a miniature website or micro-site that one might find in a wall posting in Facebook or any other web page. Such a WallWidget can be placed in any social website, website where the user has access to pasting code into the website, blog, social website, Facebook, or other available location. A WallWidget, is a portable portion of code that may be installed or executed within any separate HTML, flash, or similar based webpage, smart phone, desktop, within Facebook or any other web page, or any widget gallery as described below by an end user without necessitating additional compilation of that code portion.

The WallWidget can configure to enable a user to capture content from a subject location (i.e., website). The content could be the entire content of the location or a subset from that location. For example, the subject location can be a web site that includes images, text, video, and audio, and the user of the WallWidget can select just the text, for example, or combinations of elements, such as the text and the image. The WallWidget configures to enable the user to select linking to the content of the subject location or embedding the content of the subject location to the host location. Linked resources are stored as files within the Wall Widget; during compilation the resource data is taken from the files and placed into the API index for the application. The WallWidget then stores only a relative path or link captured content on the target or subject location and as that content changes the WebWidget is automatically “updated” by continuing to store only a pointer to the location captured. In contrast, the WallWidget can also configure to embed content captured from the subject location. When embedding, the WallWidget creates a new file saved to a library on a remote server (relative to the user). Then, when the user inserts the captured content to the host site, a mini browser is opened on the host site and the content is provided from the library to the mini browser.

The present invention includes tools to index the subject website. The subject website is indexed by the API and the API organizes links to all of the assets of the website, such as images, videos, music, chat information, links, text, and other elements of the website into a database so that they can be quickly accessed by the WallWidget and then, subsequently, to be viewed thru the WallWidget utilizing a mini browser methodology.

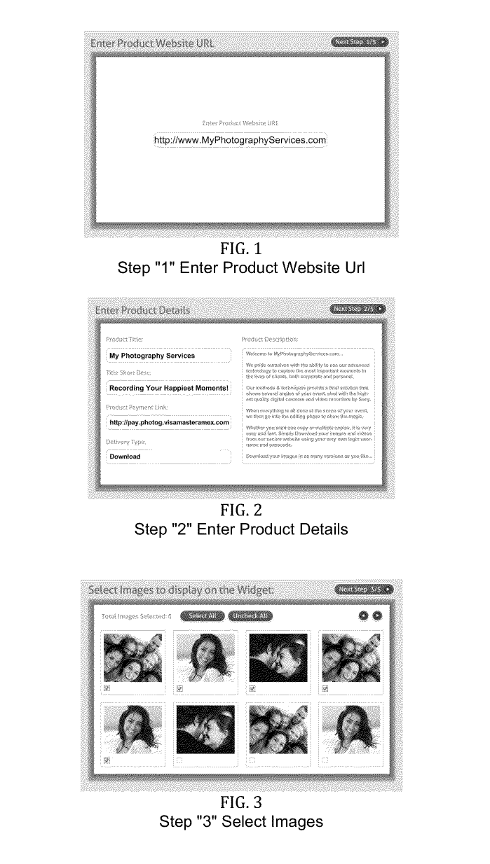

FIG. 1 illustrates Step 1 of the wizard that may be used to create the WallWidget. In the preferred embodiment step 1 shows that the user simply enters the Product Website URL of the subject website (also referred to, more broadly, as a second or target location, which can be a website, but could be any form of electronic media, web-content, files in a cloud, files on a server, images, audio recordings, visual recordings, and the like) according to an aspect of the present invention.

FIG. 2 illustrates Step 2 of the wizard that may be used to create the WallWidget. As FIG. 2 shows, Step 2 requires that the user simply enter the following elements: Product Title 16.1, which may be used as a description of the product that is offered; Title Short Desc 16.2; Product Payment Link 16.3-this enables a method for the user to pay for the product by any available online payment processing; Delivery Type 16.4, a drop-down box allowing the user to select from a number of delivery types using a hierarchal dropdown menu items that may be available such as download, physical products, memberships, or service.

FIG. 3 illustrates Step 3 of the wizard that may be used to create the WallWidget. In a preferred embodiment Step 3 shows that the user may select from the image assets that are determined by the API of the WallWidget. Once selected these images are used by the WallWidget by the API visiting the subject website and then organizing the links to the subject website assets to provide the viewer the ability to enjoy the subject website within the WallWidget.

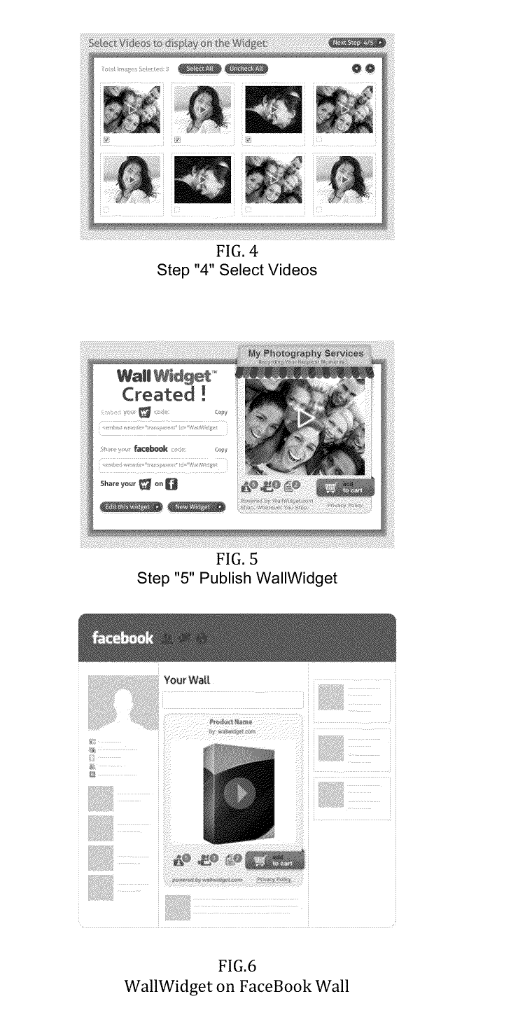

FIG. 4 illustrates Step 4 of the wizard that may be used to create the WallWidget. In this preferred embodiment, Step 4 shows that the user may select from the video assets that are determined by the API of the Wall Widget. Once selected these videos may be utilized by the WallWidget by virtue of the API visiting the subject website and then organizing the links to the subject website assets to provide the viewer the ability to enjoy the subject website within the Wall Widget.

FIG. 5 illustrates Step 5 of the wizard that may be used to create the WallWidget. In this preferred embodiment Step 5 enables the user to publish a copy of the embed code, which can be placed directly on a website and or publish directly to the user's Facebook wall by hitting a single button or by copying the code into their web page. FIG. 13 depicts the single button to share on Facebook. The embed code is determined by the API of the WallWidget.

The present invention includes a software tool or application that easily enables a user to capture content or a portion of content from one location (such as a web page, electronic document, file on a server, and the like) and to embed code pointing to that captured content in another location (such as a user's blog-site, Facebook page, other social media site, or similar). As will be understood by one of ordinary skill in the art, this software tool or application, termed herein as a “WallWidget,” is a portable portion of code that may be installed or executed within any separate HTML, flash, or similar social media site, a webpage, a smart phone, or desktop by an end user without necessitating additional compilation of that code portion.

Once the code is inserted into the desired location it will provide the viewer the ability to enjoy the subject website within the WallWidget. In viewing the WallWidget, the present invention contemplates additional tools to preview the layout of the underlying WallWidget prior to embedding that code on the destination location (that is prior to placing the captured content on the user's social website, Facebook, a website or a blog or a smart phone, for example). To customize the appearance of the WallWidget, the present invention contemplates additional tools that provide customization of fonts, colors, and screen size of the WallWidget such as to match the blog, social website, Facebook page, a website or a smart phone. This customization may be user-selectable or automatic, depending the default settings used.

FIG. 6 illustrates the WallWidget published on the wall of the Facebook owner's Facebook page. The WallWidget adapts to be placed on any Facebook page selected by the user. Distribution of WallWidgets using a blog, website, and the Social Media sites such as Facebook allows WallWidgets to become viral, and the ease in which the WallWidget can be shared may thereby increase distribution from a blog, website, or social website such as Facebook, and/or allow the user to publish WallWidgets to popular widget galleries such as iGoogle. WallWidget code portions or their entirety, as needed, are embeddable by the end user. As such, the WallWidget application adds dynamic content, and/or, in some cases, static content, to the subject webpage.

Again, the API of the present invention organizes links to the subject website assets to provide the user the ability to enjoy the subject website within the WallWidget. The WallWidget also provides direct access by a single click to the subject website to enable the user to view the subject website directly.

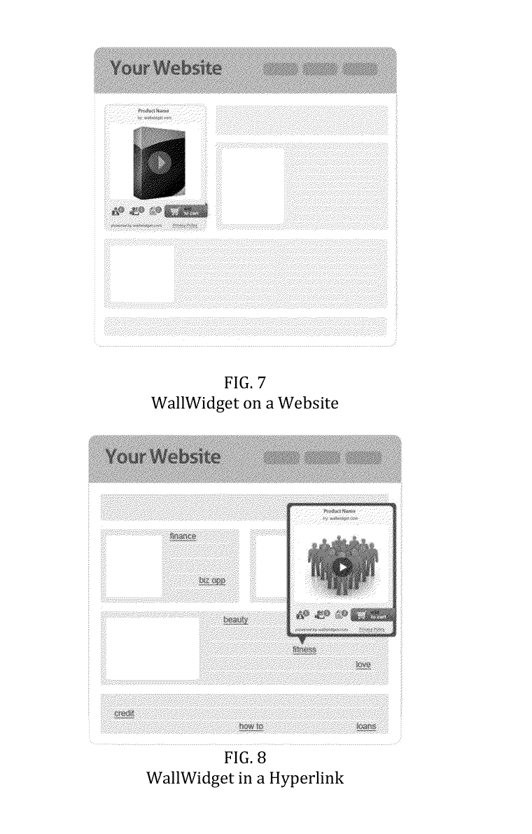

FIG. 7 illustrates the WallWidget published on any exemplary website page.

FIG. 8 illustrates a hyperlink to the WallWidget, that configures to open a preview of the WallWidget (captured content site) when a mouse-over condition occurs on the host website. Further, when in a mouse-over on the WallWidget the host page, a single mouse click on the WallWidget provides direct access to the subject website (captured content).

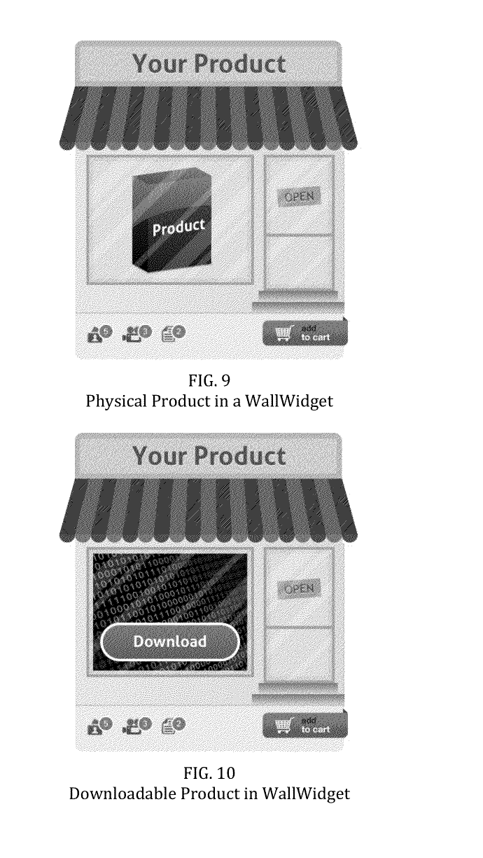

FIG. 9 illustrates an exemplary physical or service product within a virtual store with an add-to-cart button allowing the user to purchase the product of the subject website.

FIG. 10 illustrates an exemplary download product within a virtual store with an add-to-cart button allowing the user to purchase the product of the subject website.

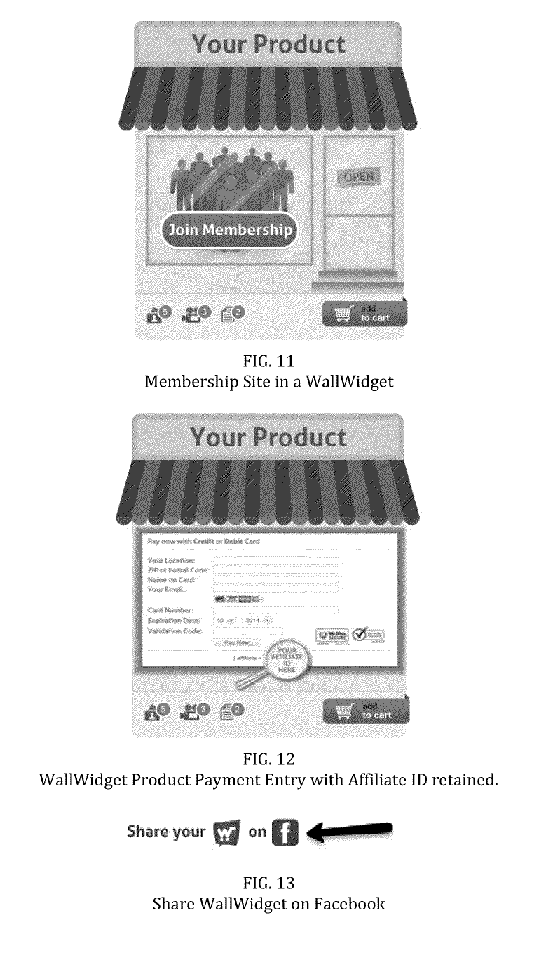

FIG. 11 illustrates an exemplary membership product within a virtual store with an add-to-cart button to allow the user to purchase the product of the subject website.

FIG. 12 illustrates an exemplary payment screen that maintains the proper affiliate ID using the API of the WallWidget as it relates to the subject website

FIG. 13 illustrates an enlarged detail of the Facebook logo along with the WallWidget logo indicating the user can share their WallWidget to Facebook with a single click using the API.

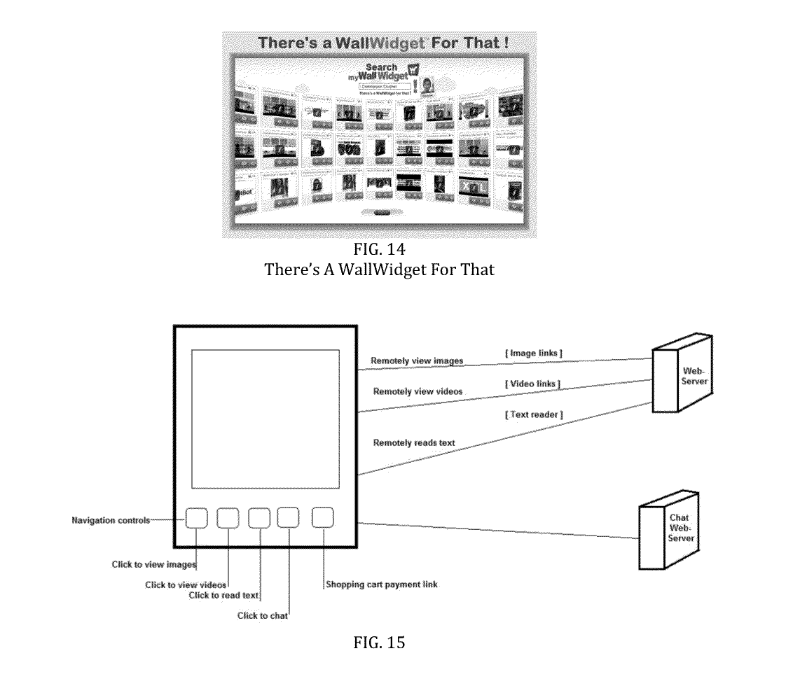

FIG. 14 illustrates a number of variants possible for the WallWidget including a library of pre-existing, pre-defined WallWidget applications that can be placed directly on a host site with pre-embeded code directing the content of the WallWidget to a captured content, second location. This feature improves user interaction and simplifies use of WallWidgets on user's social web pages, and the like. A critically important element is the search box wherein a user can type in a name of any product that may be in the database of the particular advertising network. For example, the API may provide a library of consisting of a plurality of products including sub-sets of products, for example, products offered by ClickBank.com. In this example a user might type the search term

“Provisional Patent” and be presented all of the products for sale within the ClickBank network that relate to the term “Provisional Patent”. In this way the user may choose from any one or all of the displayed thumbnails of pre-configured WallWidgets and will have the option to edit that particular WallWidget to select any one or many of the assets within the subject website.

This is in contrast to the teachings of the current art wherein the user is required to go through a lengthy and complex routine to configure the widget to his or her liking and is not assured that the affiliate link will be preserved in the future compared to the current capture intended by the user (for example, a web site is updated and the captured content is no longer available).

Additionally, the user may elect to publish the WallWidget to any one of the Social sites, blogs, or any other digital media, as described, as well as publish the WallWidget directly to a Facebook Wall with a single click. The user may even elect to delete the WallWidget from the display to keep the search results clean and tidy as well as to remove the product from their view. Such a library may be available via a particular website, via a web application, via a desktop application, or via discreet application according to an aspect of the present invention.

FIG. 15 illustrates the relationships between the subject website on its server and the link connections to the WallWidget, which remotely controls the visualization of the content of the remote website through the portable, embeddable miniature browser or WallWidget. This view illustrates some of the elements of the WallWidget as they appear in a contemplated embodiment of the present invention.

A WallWidget is the product of software programming, using an API, that is created to run inside another piece of code, such as a webpage, wherein the exemplary WallWidget allows a user to display the contents of another website, or websites, by virtue of utilizing a mini web browser. In our exemplary mode the contents of the WallWidget may be created using these exemplary five simple steps, which include: Step “1” Enter Product Website Url; Step “2” Enter Product Details; Step “3” Select Images; Step “4” Select Videos; and, Step “5” Publish WallWidget.

In this preferred embodiment, the exemplary WallWidget is not constructed by embedding content or code from one site into another site or piece of code. Instead, the WallWidget builds content by utilizing the information gathered from the exemplary steps above and organizes the links to the subject website assets to provide the viewer the ability to enjoy the subject website within the WallWidget by virtue of the API design.

As such, it is not necessary for a user to have experience in computer programming or in web design to use a WallWidget. WallWidgets allow the user to preview the display of this captured content from another location (for example, subject website). This maximizes the level of personalization, control, and simplicity of the user interaction with the web through existing social media websites, for example. Because WallWidgets are flexible (highly user adaptable) and able to be used anywhere a user goes in the online world. WallWidgets enable the user to customize the color, layout, font, and text, for example, to provide a personalized visual experience. For example, the user may want to configure a WallWidget to emulate the appearance of the user's online personality or display preference on a given social media site. WallWidgets do not require downloads, thus avoiding the dangers of spyware or adware or viruses, thereby making WallWidgets relatively safe to use. WallWidgets may be free to create, use, and customize, and or require a subscription or purchased on a per-use basis, although other models, such as a a yearly based subscription are also contemplated.

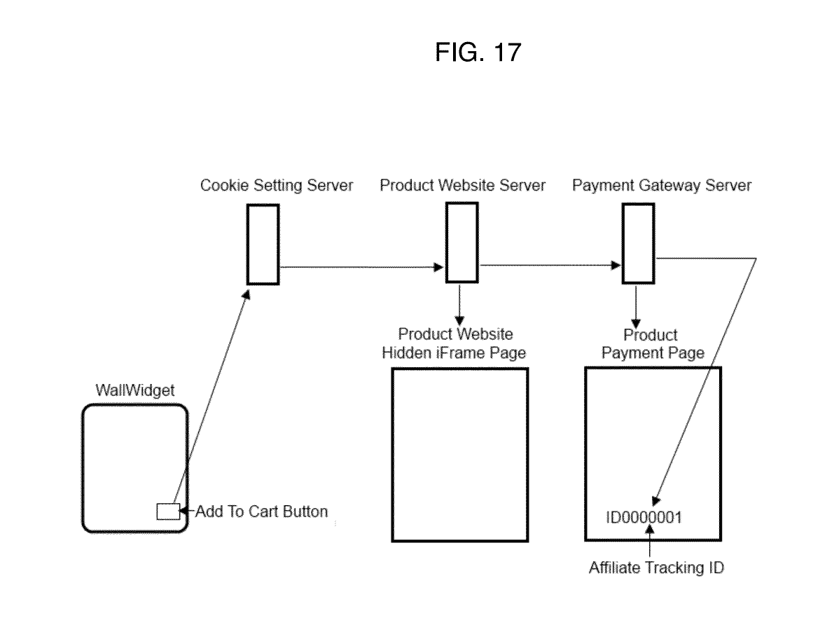

Another element of the contemplated invention includes a method step for maintaining proper credits to the proper Affiliate ID, as illustrated in FIG. 17, for example. The preferred method of maintaining proper credits to affiliates is controlled by a setting technique that makes the payment page work properly by tracking the affiliate's username through to the payment page. This contrasts to the teaching in the current art, which directs a user to interact directly with the payment page associated with that product. In the current art, the cookie will not get set on their computer, which contains the affiliate's username. For the cookie to get set, the user must first go through the network's cookie setting server. This is achieved by the consumer clicking on the affiliate's link to the product website. When the consumer clicks the affiliate link, they are redirected through the affiliate network's server where the cookie is set on their current browser, then they are sent to the website itself. Once the payment link is clicked on the website, the cookie is spawned and the affiliate's username is placed into the payment page. In prior art methods when the consumer goes directly to the payment page link, that is embedded in the webpage, they will skip the cookie setting routine that is accomplished by clicking the affiliate's tracking link first.

However, in the present invention, the API of the WallWidget takes the consumer directly to the payment page without the necessity of the user going to that webpage first. In prior art systems this method will not work to properly to track the affiliate's commissions. But, as used in the present invention, the Affiliate ID is retained when the user clicks the Shopping cart or Checkout button.

In a contemplated preferred embodiment, the present invention uses the API to link and open a page on a dedicated server that has coded the user-selected link as a frames page. The frames page first opens the product website in an invisible frame, using the affiliate's username embedded in the tracking link which is then used to open the product website page. This action sets the cookie because it goes through the normal redirect system of the affiliate network and passes through the cookie setting server and then onward to the subject website itself. The API then will wait for a couple of seconds and then close the invisible frame for the product website in the background, which is still invisible to the consumer. Once the invisible window is closed, the API opens up the payment page thereby spawning the cookie that was just set within the invisible frame and places the username in the subsequent payment page so the affiliate gets credit for the sale. This provides an extreme advantage over known art widget systems and other methods of promoting products while maintaining the proper credit to be given to the proper affiliate ID.

Further, according to an aspect of the present invention, the WallWidgets are search engine compatible and the API may be made to adjust the strategy to comply with the ever-changing and latest revisions of the search-engine search algorithms including, for example, those utilized by Google, and other search-engine companies, so that the WallWidget may be found by searching keywords within the search engines. Also, the present invention incorporates advanced marketing and sales tools based on search engine optimization and the latest in online marketing. This likely will result in superior rankings above even the subject website. The API enables the content of an implemented WallWidget to update and include sophisticated SEO strategies yet maintain the overall look of the WallWidget or the subject website. Utilizing this sophisticated strategy will allow the WallWidget to be very valuable in marketing because when a user searches (using Google, for example) for a particular search term (“provisional patent”, for example), the API of the present invention ranks higher than other websites by utilizing the viral nature of the WallWidget application. In another example, Twitter results may rank above the sites to which the “tweeter” provides a link or links and if this strategy is included in the present invention.

The viral nature of that this present invention embraces, facilitates, and promotes enables a user to enrich their social website, such as their Facebook wall, desktops, personal web pages, and blogs. The present invention enables brand decoration and such decoration may consist of all, some, or none of the following elements: title bar, border, footer artwork or partner logo, chat buttons, hyperlinks to a website, links to partner website; and/or other branding elements.

When a user incorporates the WallWidget of the present invention, this use can be tracked by a tracking system within the WallWidget API. For example, the API periodically logs into a database to record when and where the user clicks on the links and views to the various areas of the WallWidget containing the remotely viewed assets of the subject website.

Distribution of WallWidgets may allow WallWidgets to become viral by virtue of easily allowing a user to post a WallWidget on a Facebook wall. As such, the creation and distribution API of the present invention may thereby increase distribution from a website, and/or publish WallWidgets to popular widget galleries such as, in alphabetical order, Blogger,Blogger Sidebar, Live.com, My Yahoo!, AOL Bookmarks, Ask MyStuff, BackFlip, del.icio.us, Digg, Diigo, DropJack, Eons, Facebook, Faves, Furl, Get Code, Google Bookmarks, iGoogle, Linkagogo, Live Favorites, Mister Wong, NetVibes, Newsvine, PageFlakes, Piczo, Propeller, Reddit, Segnalo, Simpy, Skimbit, SlashDot, Spurl, StumbleUpon, Technorati, Twitter, TypePad, TypePad Sidebar, Webwag, and Yahoo! Bookmarks, and others by way of non-limiting example.

Further, the distribution characteristic also enables the user to directly download the WallWidget to any of the widget galleries mentioned above, to Facebook, to a desktop or to a website. Also, WallWidgets can be sent directly via email, by the user entering the name and email of a “friend” into the appropriate entry box of a WallWidget, and instructing the WallWidget API to deliver the WallWidget to the selected email. One of the keys to creating a viral distribution is the use of a LikeRageous button, similar to the Facebook “like” button. With the LikeRageous button a user may benefit from distributing the WallWidget to others within the social structure of that button.

When a user uses the WallWidget of the present invention to capture content from a subject location (website, for example), a simple version of a mini web browser is embedded in the host location. This differs from the teaching in the art, which requires storing the subject website on a particular server. The mini web browser according to the present invention enables the host location to display the present content of a specific subject website by simply maintaining a set of links to assets on the subject website. The WallWidget mini browser, therefore, is much different than maintaining all of the assets, such as videos, images, chats, and text on a server as is common in other widget applications.

Another exemplary use of WallWidgets include implementation or embedding in rewards sites, where users are rewarded with cash or gifts, for the completion of an offer, or the sale of a product, and the referral of others to the site. Accordingly, the WallWidget of the present invention includes a unique affiliate ID, which identifies the affiliate for each transaction that occurs as a result of both the affiliate publishing content on the web and a third-party interacting with that same content. The present invention utilizes this affiliate ID and maintains it on behalf of each affiliate so that they get rewarded for third-party user's interacting with a particular affiliate's content.

The WallWidget prevents the user to edit the Affiliate ID when capturing content from the affiliate's location. This is critical to maintaining proper credit for the affiliate rather than directing credit to someone other than the intended affiliate. The WallWidget maintains links to the assets rather than allowing for the creation of fraudulent links that are possible in prior art advertising or widget methodologies.

The WallWidget's API refers to and describes the code that is behind the captured content and the API is responsible for securing the behavior of the WallWidget. The API controls how the user interfaces with the WallWidget wizard and provides for proper crediting with regards to affiliate accounts. The API is responsible for organizing the links to the appropriate assets of a subject website for display within the mini browser element of the WallWidget. The API of the WallWidget may rely on JavaScript language for code. More information on JavaScript language may be found at http://developer.mozilla.org-/en-/docs-/., which is incorporated herein by reference as if fully set forth.

Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the claims. All references cited are incorporated by reference in their entirety. Although the foregoing invention has been described in detail for purposes of clarity of understanding, it is contemplated that certain modifications may be practiced within the scope of the appended claims.

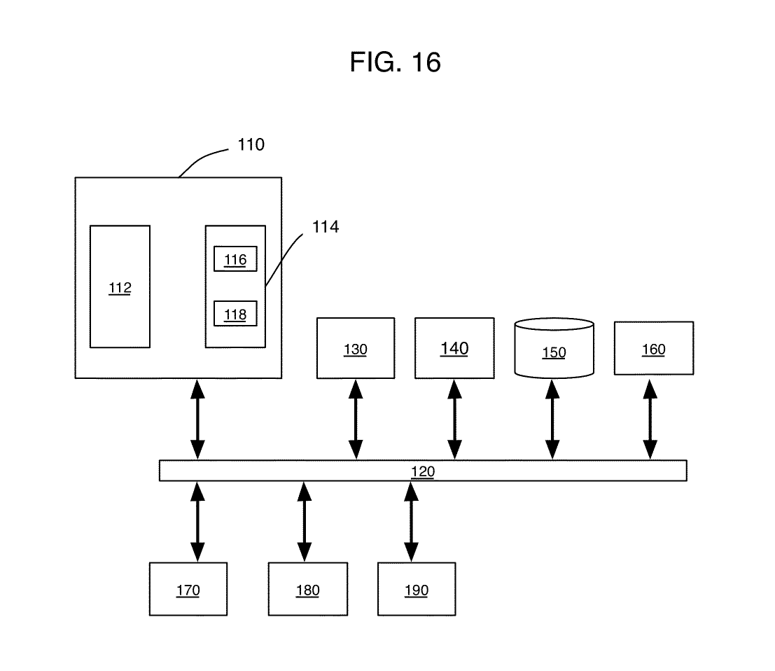

FIG. 16 shows one illustrative example of a computer 100 that can be used to implement various embodiments of the invention. The computer 100 may be incorporated within a variety of consumer electronic devices, such as personal media players, cellular phones, smart phones, personal data assistants, global positioning system devices, and the like.

As seen in this figure, computer 100 has a computing unit 110. Computing unit 110 typically includes a processor or processing unit 112 and a system memory 114. Processing unit 112 may be any type of processing device for executing software instructions, but will conventionally be a microprocessor device. System memory 114 may include both a read-only memory (ROM) 116 and a random access memory (RAM) 118. As will be appreciated by those of ordinary skill in the art, both read-only memory (ROM) 116 and random access memory (RAM) 118 may store software instructions to be executed by processing unit 112.

Processing unit 112 and system memory 114 are connected, either directly or indirectly, through a bus 120 or alternate communication structure to one or more peripheral devices. For example, processing unit 112 or system memory 114 may be directly or indirectly connected to additional memory storage, such as a removable magnetic disk drive 140, a hard disk drive 150, a flash memory card 160, and a removable optical disk drive 170. Processing unit 112 and system memory 114 also may be directly or indirectly connected to one or more input devices 180 and one or more output devices 190. Input devices 180 may include, for example, a keyboard, touch screen, a remote control pad, a pointing device (such as a mouse, touchpad, stylus, trackball, or joystick), a scanner, a camera or a microphone. Output devices 190 may include, for example, a monitor display, an integrated display, television, printer, stereo, or speakers.

Still further, computing unit 110 will be directly or indirectly connected to one or more network interfaces 130 for communicating with a network. This type of network interface 130, also sometimes referred to as a network adapter or network interface card (NIC), translates data and control signals from computing unit 110 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 130 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device 100 may be connected to a variety of other peripheral devices, including some that may perform input, output and storage functions, or some combination thereof.

In addition, computer 100 may be connected to or otherwise include one or more other peripheral devices, such as a telephone (not shown). The telephone may be, for example, a wireless “smart phone,” such as PHONE® or Droid® brand smart phones. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 100 so that their data maintained may be synchronized.

Of course, still other peripheral devices may be included with or otherwise connected to a computer 100 of the type illustrated in FIG. 16, as is well known in the art. In some cases, a peripheral device may be permanently or semi-permanently connected to computing unit 110. For example, with many computers, computing unit 110, hard disk drive 150, removable optical disk drive 170, and a display (not shown) are semi-permanently encased in a single housing.

Still other peripheral devices may be in operable communicating with, and operable connection to the computer 100, however. Computer 100 may include, for example, one or more communication ports (not shown) through which a peripheral device can be connected to computing unit 110 (either directly or indirectly through bus 120). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 100 may include a wireless data “port,” such as a Bluetooth® interface, a Wi-Fi interface, an infrared data port, or the like.

It should be appreciated that a computing device 100 may include more components than computer 100 illustrated in FIG. 16, fewer components than computer 100, or a different combination of components than computer 100. Some implementations of the invention, for example, may employ one or more computing devices 100 that are intended to have a very specific functionality, such as a smart phone or server computer. These computing devices may thus omit unnecessary peripherals, such as the network interface 130, removable optical disk drive 140, printers, scanners, external hard drives, etc. Some implementations of the invention may alternately or additionally employ computing devices 100 that are intended to be capable of a wide variety of functions, such as a desktop or laptop personal computer. These computing devices 100 may have any combination of peripheral devices or additional components as desired.

Although the invention has been particularly shown and described with reference to certain embodiments, it will be understood by those skilled in the art that various changes in form and detail may be made without departing from the spirit and scope of the invention.

I claim:

1. A computer implemented method for embedding or linking content on a host location from captured content from a subject location, the method comprising:
providing a portable portion of code that may be installed or executed within any separate host location, the portable portion of code comprising an API;
using the portable portion of code, capturing content from the subject location;
providing an affiliate ID associated with the captured content;
associating the affiliate ID in the embedded captured content on the first, host location;
using the API to link and open a page on a dedicated server that has coded the captured content as a frames page;
opening the subject location in an invisible frame;
setting a cookie with the affiliate ID by redirecting through the affiliate network's server in the invisible frame where the cookie is set on their current browser, then they are sent to the subject location;
using the affiliate's ID in a tracking link; and
using the tracking link to open the subject location in the host location.

2. The method of claim 1 further comprising:
closing the invisible frame for the subject location.

3. The method of claim 2 further comprising:
using the API, opening a payment page;
spawning the cookie from the invisible frame; and
placing the affiliate ID in the payment page.

4. The method of claim 1 further comprising:
providing the portable portion of code user tools, the user tools comprising customization of color, layout, font, and text.

5. The method of claim 1 further comprising:
providing the portable portion of code further comprising a mini web browser adapted to display the captured content on the host location.

6. The method of claim 5 further comprising:
providing one-click redirection to the subject location when a user-directed cursor is placed over the mini web browser.

7. The method of claim 1 further comprising:
enabling one-click publishing of the captured content on the host location.

8. The method of claim 1 further comprising:
providing an add-to-cart button adapted to enable a user to purchase goods or services associated with the captured content.

9. The method of claim 1 further comprising:
providing a user-interface wizard, the wizard comprising
a dialog box configured to enable the user to enter the URL of a subject location,
using the API, indexing the content of the subject location and displaying the indexed content of the subject location in a mini browser;
enabling the user to select the desired indexed content, and
capturing the content.
